(19) United States
(12) Patent Application Publication
(10) Pub. No.: US 2016/0140790 A1
(43) Pub. Date: May 19, 2016

(54) METHOD AND DEVICE FOR MARKING VALUE LABELS

(71) Applicants: JÜRGEN KRÜGER, VLOTHO (DE); RAINER ANTHONJ, RHEINAU (DE); ALAN BELL, FAREHAM (GB); JÖRG LOTTER, DARMSTADT (DE)

(72) Inventors: JÜRGEN KRÜGER, VLOTHO (DE); RAINER ANTHONJ, RHEINAU (DE); ALAN BELL, FAREHAM (GB); JÖRG LOTTER, DARMSTADT (DE)

(73) Assignee: DEUTSCHE POST AG, BONN (DE)

(21) Appl. No.: 15/004,341

(22) Filed: Jan. 22, 2016

Related U.S. Application Data
(63) Continuation of application No. 14/349,278, filed on Apr. 2, 2014.

(30) Foreign Application Priority Data
Oct. 4, 2011 (EP) 11183840.5

(51) Int. Cl. G07D 7/20; G07B 17/00; G07D 7/00; G06K 9/20

(52) U.S. Cl. CPC G07D 7/20; G06K 9/2027; G06K 9/2036; G07B 17/00185; G07D 7/0053

(57) ABSTRACT

A method is provided for detecting value labels that have been re-used, that have a surface containing a luminescent substance, and that have been applied to mailpieces that are to be transported. These mailpieces pass through a sorting system in which the presence of value labels that have a surface containing luminescent particles which are distributed essentially evenly is checked. The mailpiece having such a surface is conveyed to a marking device. Here, the substrate in the form of the surface of the value label containing luminescent particles which are distributed essentially evenly is irradiated with high-energy radiation. In this process, wherever the radiation strikes the substrate, the luminescence of the particles is destroyed to such an extent that they are no longer detected as being luminescent when they pass through the sorting system once again.

### RELATED APPLICATIONS

The present application is a continuation application of U.S. Ser. No. 14/349278, filed 2 Apr. 2014; which is a U.S. National Stage under 35 USC 371 patent application, claiming priority to Serial No. PCT/EP2012/069338, filed 1 Oct. 2012; which claims priority from EP 11183840.5, filed 4 Oct. 2011, the entirety of both of which are incorporated herein by reference.

### DESCRIPTION

The invention relates to marking labels and value stamps. In particular, the invention relates to the cancellation—by means of irradiation with high-energy radiation—of postage on mailpieces in the form of applied or printed postage indicia.

It is common practice to charge a postage fee for the transportation of mailpieces. This fee is paid in that postage indicia are purchased and glued onto the mailpiece in question. It is also possible to purchase mailpiece packaging that already has a postage indicium that is pre-printed or applied in some other manner. For letters, such mailpiece packaging is known under the name “PlusBrief” (German for “PlusLetter”). As a security feature, all of these postage indicia can be printed or have been printed with an ink that contains luminescent substances and that can be detected in sorting systems, so that mailpieces without a postage indicium or with a forged postage indicium can be recognized and, if applicable, diverted. For this purpose, the mailpieces are irradiated in the sorting system with light having wavelengths from a spectral region comprising a wavelength that is capable of exciting the luminescence of the substances. Surfaces containing luminescent substances appear under such illumination as bright areas, whereas areas without luminescent substances appear dark. The mailpieces marked with an authentic postage indicium are subsequently cancelled by means of a cancellation imprint. This cancellation imprint can be applied by means of manual stamping or else automatically, for example, with contact techniques as well as contact-free printing techniques, a process in which the postage indicium is at least partially imprinted, for example, with a non-luminescent ink, and thus at least partially covered, so that the underlying luminescent ink is covered and the postage indicium is recognized as already having been cancelled in case an attempt is made to use it a second time.

Nevertheless, it can happen that postage indicia are re-used. For one thing, this can happen accidentally, namely, because the postage indicia were not cancelled because of a system error or inadvertently because they were not cancelled during a first pass through the sorting system, or else because the cancellation imprint is so pale that it is no longer detected, at least automatically. Secondly, however, attempts are also made to remove cancellation markings, for instance, using chemical, optical and/or mechanical methods, at least to such an extent that they are no longer detected by automatic sorting systems or by the naked eye. Since these are original postage indicia, they contain luminescent printing ink and might thus be detected as authentic postage indicia in the sorting system.

The postal service provider can sustain considerable losses through such multiple uses of postage indicia.

The same problem arises in other applications in which value labels are impermissibly used multiple times, which can happen, for example, with admission tickets. By the same token, labels containing information are conceivable, for which it has to be proven beyond any doubt that this information has already been read out once before. Such labels will also be referred to below by the term “value labels”.

Before this backdrop, the objective of the invention is to put forward a method that greatly increases the detection rate of instances of re-use of value labels that have a surface containing a luminescent substance. Here, it should be possible with a high level of probability to detect value labels that inadvertently were not cancelled at the time of the first use as well as to detect manipulated value labels.

Another objective of the invention is to put forward a device with which the method can be carried out.

According to the invention, this objective is achieved by a method having the features of independent claim 1. Advantageous refinements of the method ensue from subordinate claims 2 to 11. Moreover, the objective is achieved by a device having the features of claim 12. Advantageous embodiments of the device ensue from subordinate claims 13 to 15.

The method according to the invention for detecting a value label that has been re-used, but that is intended for one-time use, and that has a surface containing a luminescent substance, whereby the value label is illuminated with light that has a first wavelength and that excites the luminescence of the luminescent substance provides that, at the time of the first use of the value label, irradiation with high-energy electromagnetic waves imparts it with a motif having a background that contrasts with the luminescent background. Such a motif can be detected if an attempt is made to use the value label another time.

In an advantageous embodiment, the contrast is created by reducing the intensity of the luminescence. When part of the surface of the value label containing the luminescent substance is irradiated with high-energy radiation, the luminescence of the substance is reduced at this place to such an extent that a contrast with the other non-irradiated part of the surface is created when the luminescence is irradiated with light having a wavelength that is capable of exciting the luminescence.

In another advantageous embodiment of the method according to the invention, the motif is a bar. Other motifs are also conceivable such as, for example, a wavy line. It has been found that such motifs can be detected reliably and quickly.

In a preferred embodiment, the high-energy radiation is generated by a light source that generates a directed light beam that is guided over the surface that is to be irradiated along a trajectory corresponding to the motif that is to be created. The light source that generates the directed light beam can be, for instance, a laser, an LED or a laser diode. The light emitted by these light sources can be further bundled by a lens system. In order to guide such a light beam along a trajectory, it is conceivable to employ a movable lens system. By the same token, however, it is also possible to direct the light beam onto a mirror system that has a movable mirror that guides the reflection of the light beam over the surface that is to be irradiated along a trajectory corresponding to the motif that is to be created. Here, the light beam can also be conveyed, for example, via a glass fiber lens system.

In another advantageous embodiment, the high-energy radiation is generated by a light source that generates a continuous beam. Accordingly, the appertaining image in the form of the motif on the surface containing a luminescent substance likewise has a continuously attenuated luminescence.

In a preferred embodiment, the high-energy radiation is generated by a light source that generates a pulsed beam. Accordingly, the appertaining image in the form of the motif on the surface containing a luminescent substance likewise has a continuous luminescence in the form of a dot matrix whose density depends on the pulse frequency.

In an especially preferred embodiment, the motif is repeated in a pattern, whereby the pattern is applied so densely that at least two motifs are applied at least partially onto the surface of the value label containing a luminescent substance. The shape of the repetitions of the motif that form the pattern can be used as a further criterion for the detection, as a result of which the recognition becomes even more reliable.

In another preferred embodiment, the value label is applied onto a surface that does not contain any luminescent substances, whereby the entire surface is irradiated with high-energy electromagnetic waves the first time the value label is used. The advantage of this embodiment is that, in order to irradiate a value label that franks a mailpiece and that is applied, for example, onto the surface of this mailpiece, the value label does not first have to be located on the surface of the mailpiece in order to mark it. Instead, the entire surface of the mailpiece can be irradiated, a process in which the value label is also irradiated.

In another embodiment of the method, the high-energy radiation is generated by a flash lamp that irradiates the surface that is to be irradiated through a template corresponding to the motif that is to be created. Advantageously, no trajectory has to be traced here, but rather, the entire motif is applied simultaneously with one flash of the flash lamp. If the motif is to be applied repeatedly in a pattern so densely that at least two motifs are applied onto the surface of the value label containing a luminescent substance, the high-energy radiation from the flash lamp can be applied through a template corresponding to the pattern that is to be created on the surface that is to be irradiated. In this manner, the entire pattern can be applied all at once with one flash of the flash lamp, thereby saving on the time needed for the application process. Here, it is possible to move the template, for instance, so that it oscillates, in order to apply a pattern or to change the pattern depicted in the template. Moreover, it is possible to operate the flash lamp as a stroboscope, whereby the frequency of the flashes is variable. For example, the frequency can be varied in the form of long-short-long flashes. In addition, it is possible to use LEDs (light-emitting diodes) instead of the flash lamp. Here, it is also conceivable to use a template of actuatable LED printheads so that a pattern can be applied.

A device according to the invention for marking a value label that is intended for one-time use and that has a surface containing a luminescent substance comprises a radiation unit with which the surface of the value label containing a luminescent substance can be irradiated with high-energy radiation that is capable of creating a motif of limited luminescence on the surface of the value label containing a luminescent substance. The light source that generates a directed light beam can be, for instance, a laser, an LED or a laser diode. The light emitted by these light sources can be further bundled by a lens system.

In an advantageous embodiment of the device, the radiation unit has a light source that generates a directed light beam that can be guided over the surface that is to be irradiated along a trajectory corresponding to the motif that is to be created. In order to guide such a light beam along a trajectory, it is conceivable to employ a movable lens system. Thus, for example, it is possible to direct the light beam onto a mirror system that has a movable mirror that guides the reflection of the light beam over the surface that is to be irradiated along a trajectory corresponding to the motif that is to be created. Here, the light beam can also be conveyed, for example, via a glass fiber lens system.

In an alternative embodiment, the radiation unit has a flash lamp that emits high-energy radiation as well as a template containing a motif, whereby the flash lamp and the template are arranged in such a way that the radiation emitted by the flash lamp strikes the surface to be irradiated through the template in such a way that the motif of the template is transferred to the value label. If the motif is to be repeated in a pattern, the template can be moved appropriately between individual flashes of the flash lamp. However, it is also possible to arrange the motif in a template repeatedly in a pattern or to arrange several templates with one or more motifs next to each other, so that an appropriate pattern is transferred onto the surface that is to be irradiated with one flash of the flash lamp. This saves on the time needed for the irradiation process.

Additional advantages, special features and advantageous refinements of the invention can be gleaned from the subordinate claims and from the presentation below of preferred embodiments making reference to the figures.

The figures show the following:

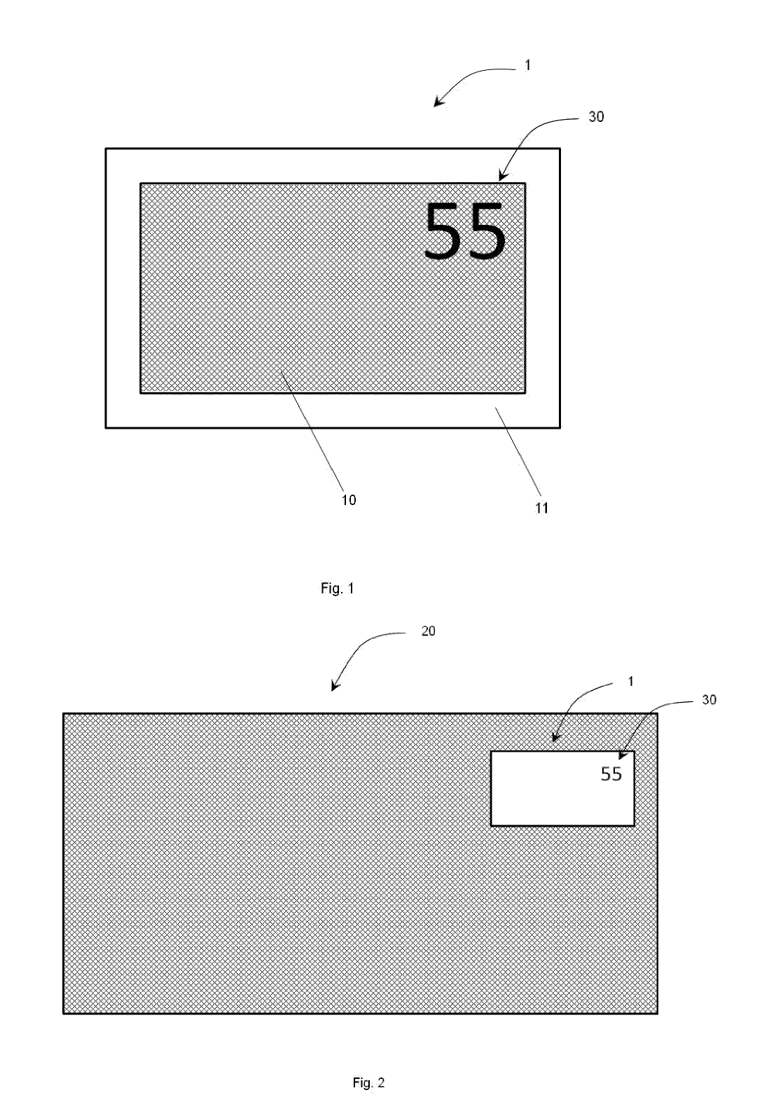

FIG. 1 a postage indicium under illumination that resembles daylight;

FIG. 2 a mailpiece surface with an applied postage indicium under illumination that excites the luminescence;

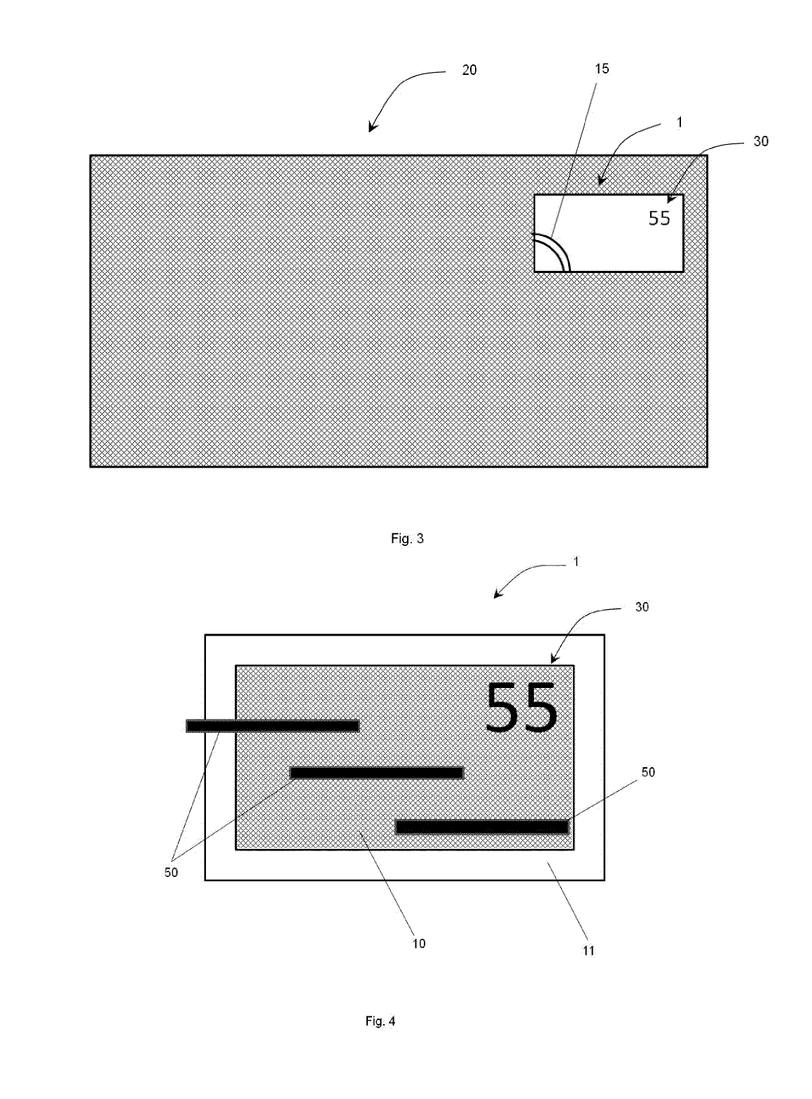

FIG. 3 a mailpiece surface with an applied postage indicium under illumination that excites the luminescence, whereby the postage indicium has been cancelled by a stamped imprint;

FIG. 4 a postage indicium marked with bars under illumination that resembles daylight;

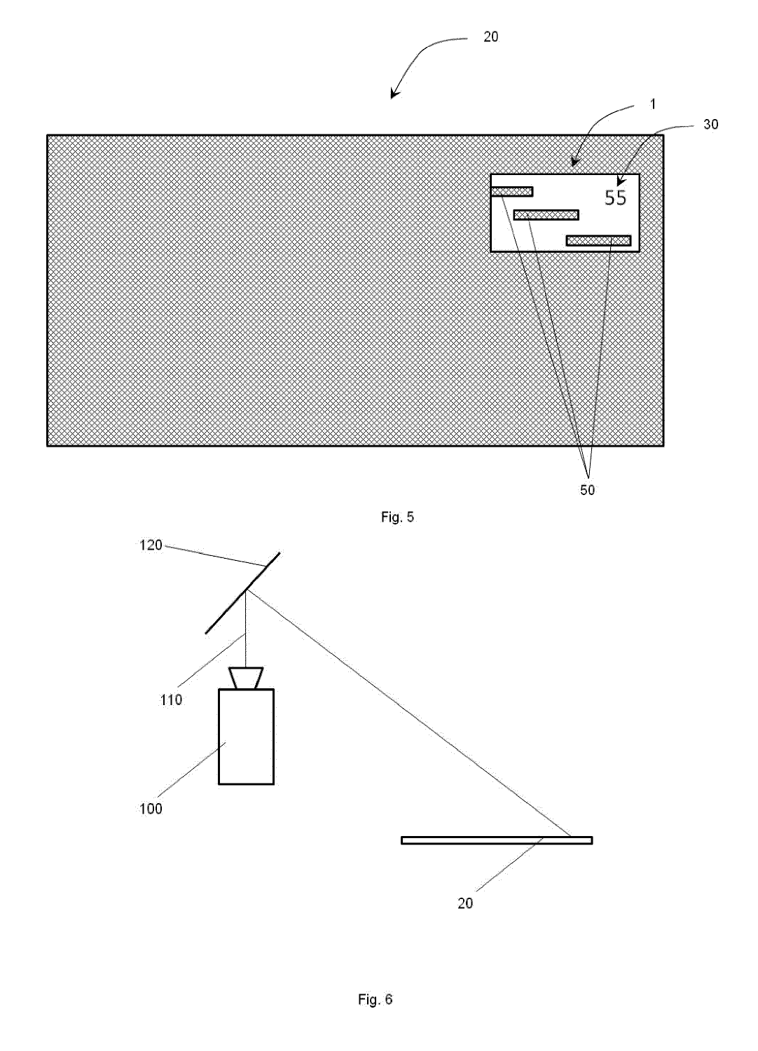

FIG. 5 a mailpiece surface with an applied postage indicium marked with bars under illumination that excites the luminescence;

FIG. 6 a schematic arrangement of a device for marking postage indicia that have been applied onto mailpiece surfaces with a laser beam that traces a trajectory;

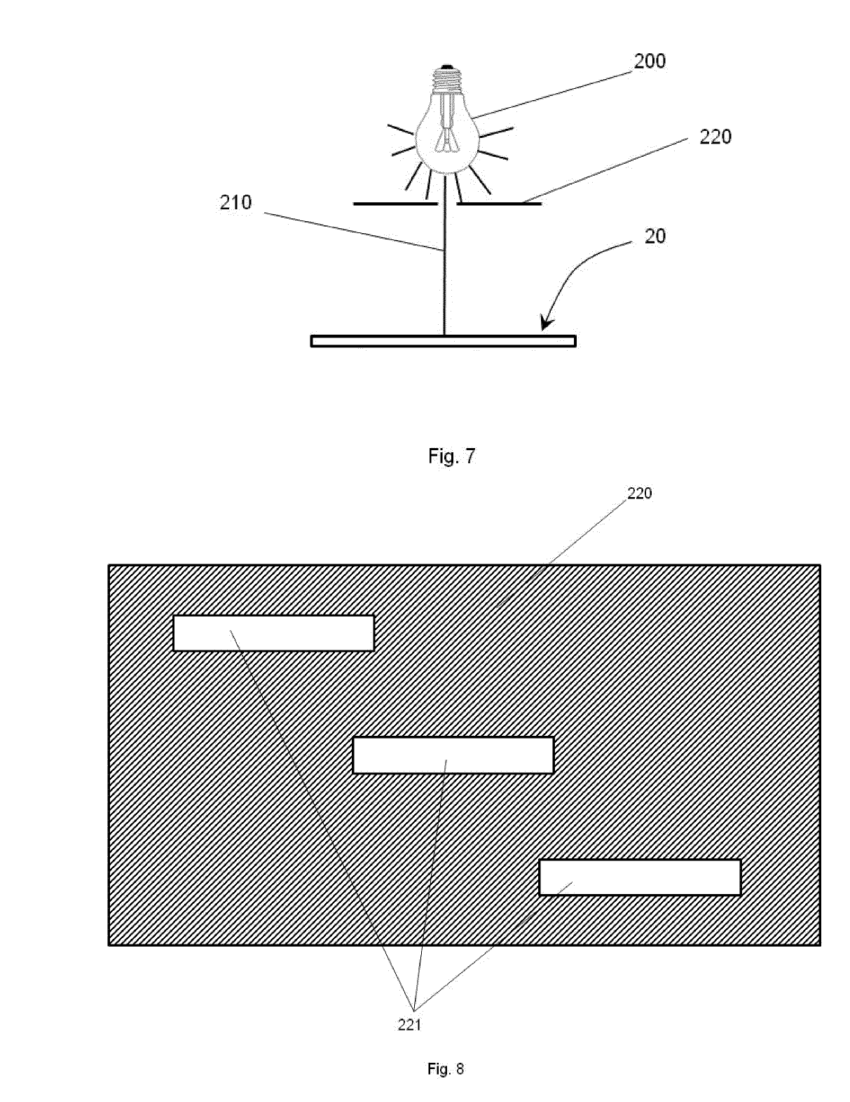

FIG. 7 a schematic arrangement of a device for marking postage indicia that have been applied onto mailpiece surfaces with a flash lamp that irradiates through a template;

FIG. 8 a top view of a template.

FIG. 1 shows a postage indicium under illumination that resembles daylight. A surface 10 is printed with printing ink containing luminescent particles. The luminescence is not visible under illumination that resembles daylight, but for the sake of clarity, the figure is shown with crosshatching. Moreover, the postage indicium has an encircling border 11 that does not contain any luminescent particles. This border has been selected here in order to illustrate the principle, but the invention does not presuppose the presence of such a border. This embodiment also provides for the imprint of a value indication 30 on the luminescent surface 10, whereby this imprint is made with a printing ink that does not contain any luminescent particles. Such a value imprint is likewise not a prerequisite in order to execute the method according to the invention, but rather, serves merely to elucidate the principle.

When the postage indicium is applied onto a mailpiece surface 20 and when it is irradiated with light having a wavelength that excites the luminescence of the particles in the printing ink on the surface 10, the mailpiece surface 20 appears dark and only the surface 10 of the postage indicium 1 containing the luminescent particles appears bright, as can be seen in FIG. 2. The border 11 of the postage indicium 1, which does not contain any luminescent particles, appears dark and cannot be identified on the dark-looking mailpiece surface 20. The value indication 30 likewise appears dark since the imprint of the value indication 30 covers the luminescent particles in this area with a non-luminescent printing ink. The postage indicium 1 is a postage indicium that is being used for the first time and that has not been cancelled, or else it is a postage indicium being used again, whereby the cancellation has been removed. Except for the value indication 30, the surface 10 containing luminescent particles appears as an essentially homogenous bright surface.

If the postage indicium 1 has been cancelled and the cancellation has not been removed, then the image of the mailpiece surface 20 containing the postage indicium 1 looks like the drawing of FIG. 3 under illumination that excites the luminescence. A stamped imprint consisting of non-luminescent ink 15 is applied over at least part of the surface 10 containing the luminescent particles and it covers the luminescent particles so that the imprint on the postage indicium can be detected. When the mailpiece is being checked for the presence of a valid postage indicium, the surface 10 containing the luminescent particles can be recognized as being illuminated in a non-homogeneous and bright manner so that consequently, the postage indicium can be classified as being invalid.

FIG. 4 shows a postage indicium 1 under illumination that resembles daylight, containing an additional marking in the form of three bars 50. As already mentioned in the description of FIG. 1, the luminescence

of the surface 10 cannot be detected under illumination that resembles daylight, but for the sake of clarity, the figure is shown with crosshatching. The bars 50 likewise cannot be detected under illumination that resembles daylight, but for the sake of clarity, they are shown in black in the figure. These bars are applied with high-energy radiation that reduces the luminescence of the appertaining particles in the printing ink that covers the surface 10.

In the situation shown in FIG. 5, a mailpiece surface 20 containing such a postage indicium 1 is viewed under illumination with light having a wavelength that excites the luminescence of the particles on the surface 10. The surface 10 no longer appears essentially homogeneously bright as shown in FIG. 2. Instead, the bars 50 look dark, like the rest of the mailpiece surface 20, which does not contain a postage indicium 1, as is indicated in FIG. 5 by crosshatching. A section of an image that contains the postage indicium 1 and that was taken under these conditions is compared to a reference image on which the same postage indicium is imaged under the same illumination while still in its new condition, as a result of which the bars 50 can be detected as the difference between the two images and the postage indicium can be characterized as having been re-used. Such a mailpiece can be diverted from the process and can undergo a separate treatment.

FIG. 6 shows the principle of an embodiment of a device for the systematic, pattern-like application of the high-energy radiation onto the surface 10 of the postage indicium 1 that has been applied onto a mailpiece surface 20 and that contains luminescent particles. The source of radiation used is a laser 100 that emits a high-energy beam 110, for example, in the wavelength range of UV or IR radiation. This beam 110 is directed at a mirror 120, whereby this mirror can be spatially tilted. A controlled movement of this mirror 120 deflects the beam 110 in such a way that it traces trajectories on the surface 10 of the postage indicium 1 that has been applied onto a mailpiece surface 20 and that contains luminescent particles, and wherever it strikes the surface 10, it reduces or even destroys the luminescence of the particles. The trajectories can be straight sections so that bars 50 are generated with a reduced luminescence on the surface 10 of the postage indicium that has been applied onto a mailpiece surface 20 and that contains luminescent particles. However, the trajectories can also be wavy lines or else other patterns that create corresponding patterns having less luminescent areas on the surface 10 of the postage indicium that has been applied onto a mailpiece surface 20 and that contains luminescent particles.

Tracing trajectories takes time, something which can limit the throughput rate of mailpieces through the device. The alternative embodiment shown in FIG. 7 of a device that is suitable for carrying out the method according to the invention is capable of generating such patterns more quickly on the surface 10 of the postage indicium that has been applied onto a mailpiece surface 20 and that contains luminescent particles. The device has a flash lamp 200 that emits stroboscope-like high-energy radiation, for example, in the UV or IR range. Between the flash lamp 200 and the mailpiece surface 20 that is to be irradiated, there is a template 220 that, as shown in FIG. 8, has cutouts 221 that are analogous to the pattern 50 that is to be applied. Most of the radiation emitted by the flash lamp 200 is prevented by the template 220 from striking the mailpiece surface 20. However, beams 210 that can pass through a cutout 221 of the template 220 strike the surface 10 of the postage indicium 1 that has been applied onto a mailpiece surface 20 and that contains luminescent particles, thereby reducing the luminescence of the particles punctually. The selection of the shape of the cutout 221 of the template 220 can determine the pattern that is supposed to be created on the surface 10 of the postage indicium 1 that has been applied onto a mailpiece surface 20 and that contains luminescent particles. In this process, the flash lamp 200 shines through the template 220, simultaneously illuminating all of the areas whose luminescence is supposed to be reduced, so that such a device can operate faster than the device with the laser 100 and the mirror 120 shown in FIG. 6.

In the embodiments shown in the figures, postage indicia are described as value labels. Of course, any other value label that has a surface 10 containing luminescent particles can be handled in the manner described.

### LIST OF REFERENCE NUMERALS

value label, postage indicium
10 surface containing luminescent particles
11 surface containing non-luminescent particles
15 cancellation imprint
20 mailpiece surface
30 value indication
50 marking, motif
100 laser
110 laser beam
120 minor
200 flash lamp
210 light beam from the flash lamp
220 template
221 cutout

1. A method for detecting a value label that has been re-used, but that is intended for one-time use, and that has a surface containing a luminescent substance, the method comprising:
illuminating the value label with light that has a first wavelength and that excites a luminescence of the luminescent substance, wherein at the time of the first use of the value label, irradiation with high-energy electromagnetic waves imparts it with a motif having a background that contrasts with the luminescent background.

2. The method according to claim 1, whereby the contrast is created by reducing the intensity of the luminescence.

3. The method according to claim 1, wherein the motif is a bar.

4. The method according to claim 1, wherein the motif is a wavy line.

5. The method according to claim 1, wherein the high-energy radiation is generated by a light source that generates a directed beam that is guided over the surface that is to be irradiated along a trajectory corresponding to the motif that is to be created.

6. The method according to claim 1, wherein the high-energy radiation is generated by a light source that generates a continuous beam.

7. The method according to claim 1, wherein the high-energy radiation is generated by a light source that generates a pulsed beam.

8. The method according to claim 1, wherein the motif is repeated in a pattern, whereby the pattern is applied so densely that at least two motifs are applied at least partially onto the surface of the value label containing a luminescent substance.

9. The method according to claim 1, wherein the value label is applied onto a surface that does not contain any luminescent substance, and the entire surface is irradiated with high-energy electromagnetic waves at the time of the first use of the value label.

10. The method according to claim 1, wherein the high-energy radiation is generated by a flash lamp that irradiates the surface that is to be irradiated through a template corresponding to the motif that is to be created.

11. The method according to claim 2, wherein the motif is repeated in a pattern, whereby the pattern is applied so densely that at least two motifs are applied at least partially onto the surface of the value label containing a luminescent substance, and the value label is applied onto a surface that does not contain any luminescent substances, and the entire surface is irradiated with high-energy electromagnetic waves at the time of the first use of the value label, and the high-energy radiation is generated by a flash lamp that irradiates the surface that is to be irradiated through a template corresponding to the motif that is to be created.

12. A device for marking a value label that is intended for one-time use and that has a surface containing a luminescent substance, the device comprising:
a radiation unit with which the surface of the value label containing a luminescent substance is irradiated with high-energy radiation that is capable of creating a motif of limited luminescence on the surface of the value label containing a luminescent substance, whereby the motif is repeated in a pattern, whereby the pattern is applied so densely that at least two motifs are applied at least partially onto the surface of the value label containing a luminescent substance.

13. The device according to claim 12, wherein the radiation unit comprises a light source that generates a directed light beam that is guided over the surface that is to be irradiated along a trajectory corresponding to the motif that is to be created.

14. The device according to claim 12, wherein the radiation unit comprises flash lamp that emits high-energy radiation as well as a template containing a motif, whereby the flash lamp and the template are arranged in such a way that the radiation emitted by the flash lamp strikes the surface to be irradiated through the template in such a way that the motif of the template is transferred to the value label.

15. The device according to claim 12, wherein the radiation unit comprises a flash lamp that emits high-energy radiation as well as a template containing a motif, whereby the flash lamp and the template are arranged in such a way that the radiation emitted by the flash lamp strikes the surface to be irradiated through the template in such a way that the motif of the template is transferred to the value label.
